(19) United States
(12) Patent Application Publication
(10) Pub. No.: US 2011/0183545 A1
(43) Pub. Date: Jul. 28, 2011

(54) ELECTRICAL CONNECTOR WITH METALLIC SHELL FIRMLY RETAINED WITH THE INSULATIVE HOUSING

(75) Inventors: JING-JIE GUO, Shenzhen (CN); JIN-LIANG DU, Shenzhen (CN)

(73) Assignee: HON HAI PRECISION INDUSTRY CO., LTD., New Taipei (TW)

(21) Appl. No.: 13/013,857

(22) Filed: Jan. 26, 2011

(30) Foreign Application Priority Data
Jan. 28, 2010 (CN) 201020301787.2

(51) Int. Cl. H01R 13/648

(52) U.S. Cl. 439/607.01

(57) ABSTRACT

An electrical connector (100) includes an insulative housing (1) comprising a base portion (10) and a tongue portion (11) extending from the base portion, a number of contacts (2) assembled in the insulative housing, and a metallic shell (4) having a casing portion (41) covering the tongue portion of the insulative housing. A space (12) is defined in the base portion. The insulative housing has a vertical wall (103) terminating the space and a plurality of bulges (18) extending from the vertical wall. The bulges protrude into the space. The casing portion forms a locking portion (413) extending in the space and being embedded in the bulges.

### BACKGROUND OF THE INVENTION

1. Field of the Invention

The present invention relates generally to an electrical connector, and more particularly to an electrical connector with a metallic shell firmly retained with the insulative housing.

2. Description of Related Arts

U.S. Pat. No. 7,771,236 issued to Koyama et al. on Aug. 10, 2010, discloses a USB connector comprising an insulative housing, a plurality of contacts assembled in the insulative housing, and a shield covering the insulative housing. The insulative housing has a base portion and a tongue portion extending forwardly from the base portion for connecting a mating connector along a mating direction. A space is formed inside the base portion and communicates with outside at a front face of the base portion. The shield comprises a casing portion covering the tongue portion and an upper wall connected to the casing portion through a bent portion. The upper wall is attached to the base portion of the insulative housing for retaining the shield on the insulative housing. The casing portion comprises an upper face connected to the bent portion, a lower face opposite to the upper face, and a pair of side faces connected with the upper face and the lower face. The lower face and the side faces extend over the bent portion to be substantially cantilevered below the upper wall as a locking portion. The locking portion is inserted into the space when the shield is attached to the insulative housing for increasing strength of the tongue portion. Because the space is normally larger than thickness of both the lower face and the side faces, the locking portion is smoothly inserted into the space. However, the locking portion may shake in the space, even likely eject out of the space along the opposite direction.

Hence, an electrical connector with a metallic shell firmly retained with the insulative housing is desired.

### SUMMARY OF THE INVENTION

Accordingly, an object of the present invention is to provide an electrical connector with a metallic shell firmly retained with the insulative housing.

To achieve the above object, an electrical connector includes an insulative housing comprising a base portion and a tongue portion extending from the base portion, a number of contacts assembled in the insulative housing, and a metallic shell having a casing portion covering the tongue portion of the insulative housing. A space is defined in the base portion. The insulative housing has a vertical wall terminating the space and a plurality of bulges extending from the vertical wall. The bulges protrude into the space. The casing portion forms a locking portion extending in the space and being embedded in the bulges.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of an electrical connector constructed in accordance with the present invention, and wherein a printed circuit board is shown;

FIG. 2 is a perspective, fully exploded view of FIG. 1;

FIG. 3 is a perspective view of the insulative housing;

FIG. 4 is a cross-sectional view taken along line 4-4 of FIG. 3;

FIG. 5 is a cross-sectional view taken along line 5-5 of FIG. 1; and

FIG. 6 is a cross-sectional view taken along line 6-6 of FIG. 1.

### DETAILED DESCRIPTION OF THE PREFERRED EMBODIMENT

Reference will now be made in detail to the preferred embodiment of the present invention.

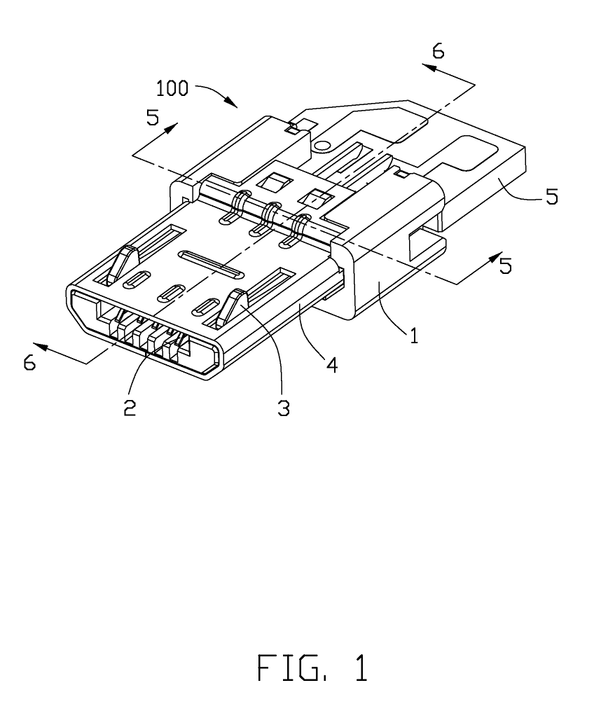

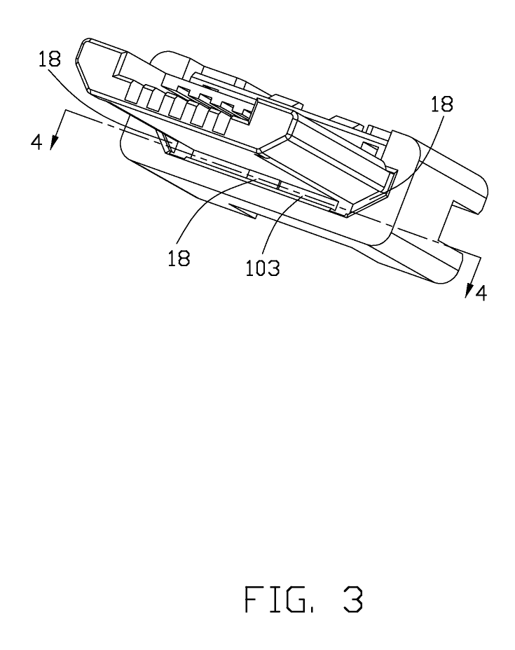

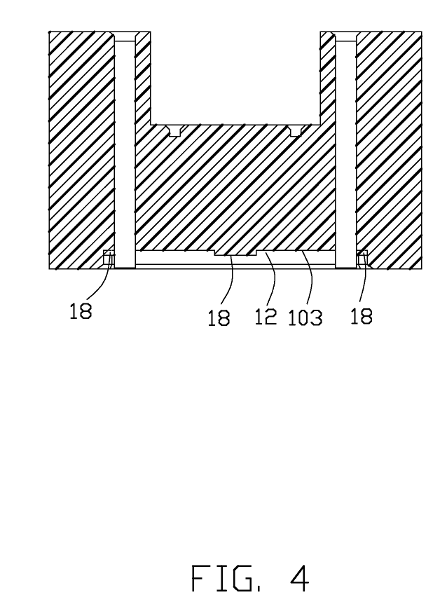

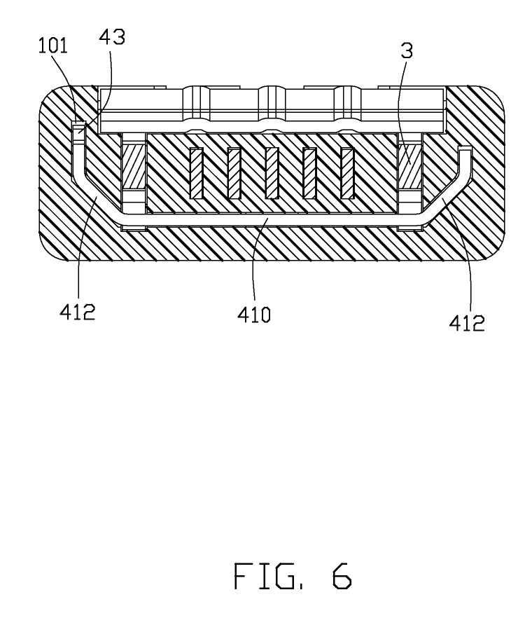

Referring to FIGS. 1-6, an electrical connector 100 in accordance with the present invention, used for receiving a mating connector (not shown) along a mating direction, comprises an insulative housing 1, a plurality of contacts 2 assembled in the insulative housing 1, a pair of latches 3 assembled in the insulative housing 1, too, and a metallic shell 4 covering the insulative housing 1. A printed circuit board 5 is sandwiched by the contacts 2 for electrical connection.

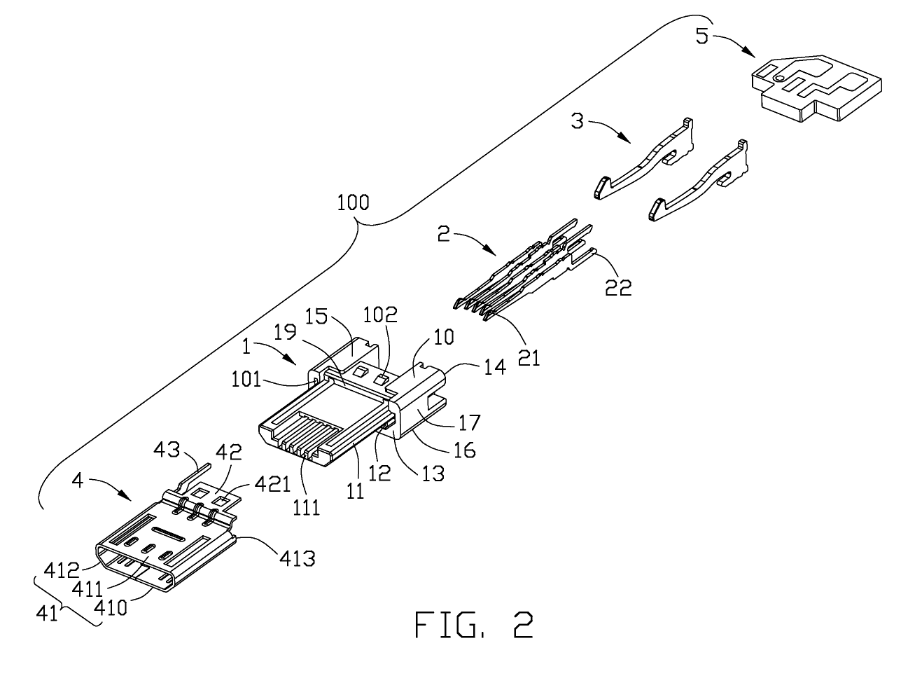

Referring to FIGS. 2-4, the insulative housing 1 comprises a base portion 10 and a tongue portion 11 extending forwardly from the base portion 10. The base portion 10 defines a front face 13, a rear face 14 opposite to the front face 13, a top face 15, a bottom face 16 opposite to the top face 15, and a pair of lateral faces 17. A space or groove 12 is defined inside the base portion 10 and communicates with outside at the front face 13 of the base portion 10. The space 12 is provided over a whole circumference except an upper front wall surface 19 which connects the tongue portion 11 and the base portion 10 at the front face 13. A vertical wall 103 is formed inside the space 12 which connects the top face 15 and the bottom face 16. The tongue portion 11 integrally extends from the vertical wall 103. A plurality of soft, plastic bulges 18 protrudes from the vertical wall 103 and into the space 12. In a preferred embodiment, the number of the bulges 18 is three, with one thereof is at the lower part of the space 12 and the other two respectively at two sides of the space 12. Connecting lines of the three bulges 18 are constructed in a triangle. The tongue portion 11 defines a plurality of passageways 111 extending along the mating direction. The base portion 10 further defines a slit 101 besides the space 12 extending through from the front face 13 and the rear face 14. The base portion 10 forms a pair of protrusions 102 on the top face 15.

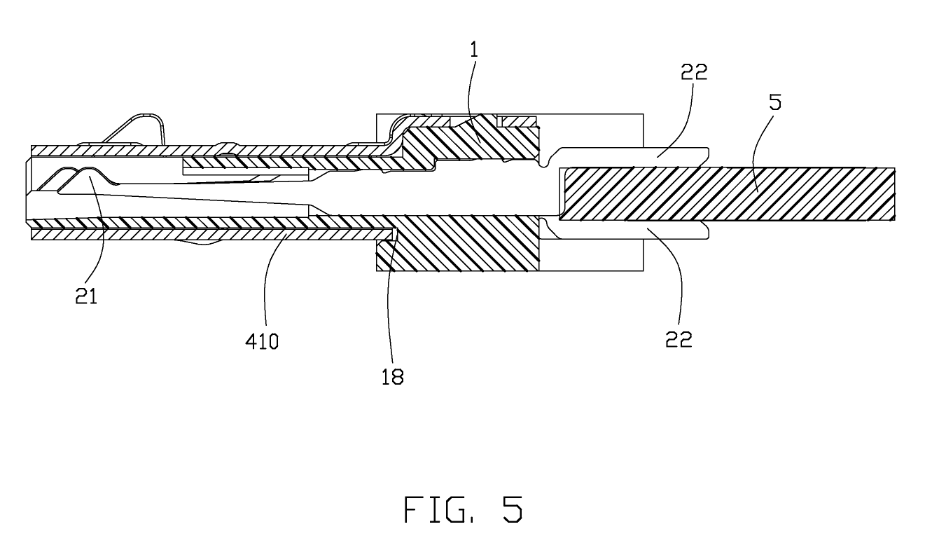

Referring to FIGS. 2 and 5, the contacts 2 comprises a plurality of contacting portions 21 received in the passageways 111 and a plurality of soldering portions 22 extending out of the insulative housing 1 from the rear face 14. Each contact 2 extends in a vertical plane and the contacting portions 21 are arranged in a first horizontal plane perpendicular to the vertical plane. The soldering portions 22 alternately bend from the contacting portions 21 and are arranged in two different horizontal planes, with one above the first horizontal plane and the other below the first horizontal plane. The soldering portions 22 sandwich the printed circuit board 5.

Referring to FIGS. 1, 2, 5 and 6, the metallic shell 4 comprises a casing or tubular portion 41 and a sleeve or flange portion 42 extending upwardly, rearward from the casing portion 41. The casing portion 41 shields over the tongue portion 11 of the insulative housing 1. The casing portion 41 comprises an upper wall 411, a lower wall 410 opposite to the upper wall 411, and a pair of side walls 412 connecting with the upper wall 411 and the lower wall 410. The lower wall 410 and the side walls 412 extend farther than the upper wall 411, forming a locking portion 413 cantilevered below the sleeve portion 42. The sleeve portion 42 is attached to the top face 15 of the base portion 10. The sleeve portion 42 defines a pair of cutouts 421 correspondingly retaining the protrusions 102 of the base portion 10 for fixing the metallic shell 3 on the insulative housing 1. The casing portion 41 laterally forms a shaft 43 extending rearward therefrom. The shaft 43 extends through the slit 101 and contacts a grounding pad (not labeled) of the printed circuit board 5.

Referring to FIGS. 1-6, when the metallic shell 4 is assembled onto the insulative housing 1, the locking portion 413 comprising the rear edges of the lower wall 410 and the side walls 412 is inserted into the space 12 and is further embedded into the bulges 18 such that the casing portion 41 is fixedly secured with the insulative housing 1. The metallic shell 1 is prevented from shaking or being separated from the insulative housing 1.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical connector comprising:
an insulative housing comprising a base portion and a tongue portion extending from the base portion, a space being defined in the base portion, the insulative housing forming a vertical wall terminating the space and a plurality of bulges extending from the vertical wall, the bulges protruding into the space;
a plurality of contacts assembled in the insulative housing; and
a metallic shell having a casing portion covering the tongue portion of the insulative housing, the casing portion forming a locking portion extending in the space and being embedded in the bulges.

2. The electrical connector as claimed in claim 1, wherein the number of the bulges is three and connecting lines of the three bulges are constructed in a triangle.

3. The electrical connector as claimed in claim 2, wherein the base portion defines a front face, a rear face opposite to the front face, a top face, a bottom face opposite to the top face, and a pair of lateral faces, and the space communicates with outside at the front face of the base portion.

4. The electrical connector as claimed in claim 3, wherein the space is provided over a whole circumference except an upper front wall surface which connects the tongue portion and the base portion at the front face.

5. The electrical connector as claimed in claim 3, wherein one of the three bulges is at the lower part of the space and the other two bulges are respectively at two upper sides of the space.

6. The electrical connector as claimed in claim 5, wherein the casing portion comprises an upper wall, a lower wall opposite to the upper wall, and a pair of side walls connecting with the upper wall and the lower wall, and the locking portion is the rear edges of the lower wall and the side walls.

7. The electrical connector as claimed in claim 6, wherein the lower wall and the side walls extend farther than the upper wall.

8. The electrical connector as claimed in claim 7, wherein the metallic shell further comprises a sleeve portion connecting to the upper wall of the casing portion through a bent portion, and the sleeve portion is attached to the base portion.

9. The electrical connector as claimed in claim 1, wherein the base portion defines a slit, and the casing portion forms a shaft extending through the slit for connecting a printed circuit board.

10. The electrical connector as claimed in claim 9, wherein the contacts comprise a plurality of a plurality of contacting portions for connecting with a mating connector and a plurality of soldering portions extending out of the insulative housing, and the soldering portions sandwich the printed circuit board.

11. An electrical connector comprising:
an insulative housing defining a base portion with a tongue portion forwardly extending therefrom and spanning in a transverse direction with a mating face thereon above which a mating port is formed;
a metallic shell attached to the housing and enclosing both said base portion and said tongue portion;
a plurality of passageways disposed in the housing and extending in a front-to-back direction perpendicular to said transverse direction;
a first set of contacts disposed in the housing, each of said contacts stamped from sheet metal and lying in a vertical plane perpendicular to said transverse direction, and
each of said contacts further defining a retention section retained within the corresponding passageway, a contacting section extending forwardly from the retention section with a contacting apex protruding out of the mating face in a first vertical direction perpendicular to both said transverse direction and said front-to-back direction, and into the mating port, and a tail section extending rearwardly from the retention section and defining a board mounting face extending in the front-to-back direction and facing in a second vertical direction opposite to said first vertical direction; wherein
the base portion defines an aperture and the metallic shell defines unitarily a shaft rearwardly extending into the aperture.

12. The electrical connector as claimed in claim 11, further including a printed circuit board on which the board mounting faces are seated and the shaft mechanically and electrically is connected.

13. The electrical connector as claimed in claim 11, wherein the base portion defines a groove in a front face to receive a rear edge of a sleeve section of the shell under condition that a protrusion is formed in the groove to abut against the rear edge of the sleeve section of the shell.

14. An electrical connector comprising:
an insulative housing defining a base portion and a tongue portion extending forwardly from a front face of the base portion with a mating face thereon;
a plurality of contacts disposed in the housing, each of said contacts defining a contacting section exposed on the tongue portion, and a tail section exposed behind the base portion; and
a metallic shell attached to the housing and including a tubular section enclosing the tongue portion and a flange section extending rearwardly from the tubular section; wherein
the base portion defines a groove in the front face to receive a rear edge of the tubular section of the shell, and the flange section is locked to the base portion.

15. The electrical connector as claimed in claim 14, wherein a plurality of bulges are formed in the groove and surround the tongue portion to forwardly abut against the rear edge of the tubular section of the shell.

16. The electrical connector as claimed in claim 15, wherein said bulges transversely direct to faces of the tongue portion except said mating face.

17. The electrical connector as claimed in claim 14, wherein said shell further includes a shaft extending rearwardly to mechanically and electrically connect a corresponding grounding pad on a printed circuit board which is disposed behind the base portion and which the tail sections of the contacts are seated on.

18. The electrical connector as claimed in claim 17, wherein said base portion defines an aperture receiving said shaft.

19. The electrical connector as claimed in claim 17, wherein the shaft is transversely spaced from the flange section.

20. The electrical connector as claimed in claim 14, wherein the rear edge of the tubular section forms rearwardly extending locking portion,
